(19) United States
(12) Patent Application Publication
(10) Pub. No.: US 2019/0229845 A1
(43) Pub. Date: Jul. 25, 2019

(54) RECORDING MEDIUM RECORDING MESSAGE INFORMATION ACQUISITION PROGRAM, INFORMATION PROCESSING APPARATUS, AND MESSAGE INFORMATION ACQUISITION METHOD

(71) Applicant: Fujitsu Limited, Kawasaki-shi (JP)

(72) Inventors: Taki KONO, Kodaira (JP); AKIRA Kato, Yachiyo (JP); Kosei Takano, Fujimino (JP); Machiko Kawamura, Kawasaki (JP); Yukio Sato, Ota (JP); Kanami Hitsuda, Yokohama (JP); Teruaki Nakayama, Setagaya (JP); Hiroki Nikai, Ota (JP)

(73) Assignee: Fujitsu Limited, Kawasaki-shi (JP)

(21) Appl. No.: 16/367,352

(22) Filed: Mar. 28, 2019

Related U.S. Application Data
(63) Continuation of application No. PCT/JP2016/079132, filed on Sep. 30, 2016.

(51) Int. Cl. H04L 1/00; H04W 28/04; H04L 1/08

(52) U.S. Cl. CPC H04L 1/0045; H04W 88/08; H04L 1/08; H04W 28/04

(57) ABSTRACT

A non-transitory computer-readable recording medium having stored therein a message information acquisition program for causing a computer to execute a process includes: receiving, from each of a plurality of base stations that receive a first message which is transmitted by a communication terminal, a second message in which information indicated by the first message is divided into parts each in an error checkable format; performing an error check for each of the parts; extracting, in each of a plurality of second messages indicating the same information, a divided piece of information from one or more parts without an error of the parts; joining the divided pieces of information; and acquiring the information indicated by the first message.

### CROSS-REFERENCE TO RELATED APPLICATION

This application is a continuation application of International Application PCT/JP2016/079132 filed on Sep. 30, 2016 and designated the U.S., the entire contents of which are incorporated herein by reference.

### FIELD

The embodiments discussed herein are, related to a message information acquisition program, a message information acquisition apparatus, and a message information acquisition method.

### BACKGROUND

Error data is repaired when an error occurs in received data.

Japanese Laid-open Patent Publication No 2005-294923 is disclosed as related art.

### SUMMARY

According to an aspect of the embodiments, a non-transitory computer-readable recording medium having stored therein a message information acquisition program for causing a computer to execute a process includes: receiving, from each of a plurality of base stations that receive a first message which is transmitted by a communication terminal, a second message in which information indicated by the first message is divided into parts each in an error checkable format; performing an error check for each of the parts; extracting, in each of a plurality of second messages indicating the same information, a divided piece of information from one or more parts without an error of the parts; joining the divided pieces of information; and acquiring the information indicated by the first message.

The object and advantages of the invention will be realized and attained by means of the elements and combinations particularly pointed out in the claims.

It is to be understood that both the foregoing, general description and the following detailed description are exemplary and explanatory and are not restrictive of the invention.

### BRIEF DESCRIPTION OF DRAWINGS

FIG. 1 is a diagram for explaining an outline of a communication system according to an embodiment of the present invention;

FIG. 2 is a functional block diagram of a message information acquisition apparatus according to the present embodiment;

FIG. 3 is a diagram illustrating an example of a data format of a message;

FIG. 4 is a block diagram illustrating a schematic configuration of a computer functioning as the message information acquisition apparatus according to the present embodiment;

FIG. 5 is a sequence diagram illustrating exchange of information between the message information acquisition apparatus, base stations, and a communication terminal;

FIG. 6 is a flowchart illustrating n example of a message information acquisition process;

FIG. 7 is a diagram illustrating an example of messages in which the occurrence of an error is specified for each piece of partial information;

FIG. 8 is a diagram illustrating an example of messages in which the occurrence of an error is specified for each piece of partial information;

FIG. 9 is a diagram illustrating another example of the data format of the message; and

FIG. 10 is a flowchart illustrating another example of the message information acquisition process.

### DESCRIPTION OF EMBODIMENTS

For example, a digital broadcasting system that locates an uncorrectable error packet included in data when retaining the data in a built-in recording medium and requires the correct packet of a portion corresponding to the located error packet from a server that is a data supply source has been proposed. In this system, the correct packet supplied from the server is replaced with the error packet and retained.

For example, communication between a plurality of base stations and a communication terminal carried on a mobile body, such as communication between a ship and a base station disposed in a coastal area or the like, is performed. In a case where reliable communication between the communication terminal and the base station is desired, it is conceivable to use satellite communication or the like, while a communication system using satellite communication is expensive. Accordingly, in order to perform communication over a long distance at low cost, communication utilizing the reflection of radio waves of a shortwave band frequency at the ionosphere is used for communication between the communication terminal and the base station.

In the communication utilizing the ionospheric reflection, communication is sometimes disabled because an area that radio waves reach changes and radio waves pass through the ionosphere depending on the condition of the ionosphere. Therefore, there are cases where an error such as superimposition of noise or the occurrence of a missing part occurs in a message received by one base station and information indicated by the message may not be acquired with high accuracy.

For example, it is conceivable to request the communication terminal which is the transmission source of the message to reseed the message; however, as described above, in the communication utilizing the ionospheric reflection, there is a high possibility that an error occurs also in the resent message and the error is not satisfactorily repaired in some cases.

For example, information may be acquired with high accuracy even when the communication quality is low.

Hereinafter, an example of embodiments according to the disclosed technology will be described in detail with reference to the drawings.

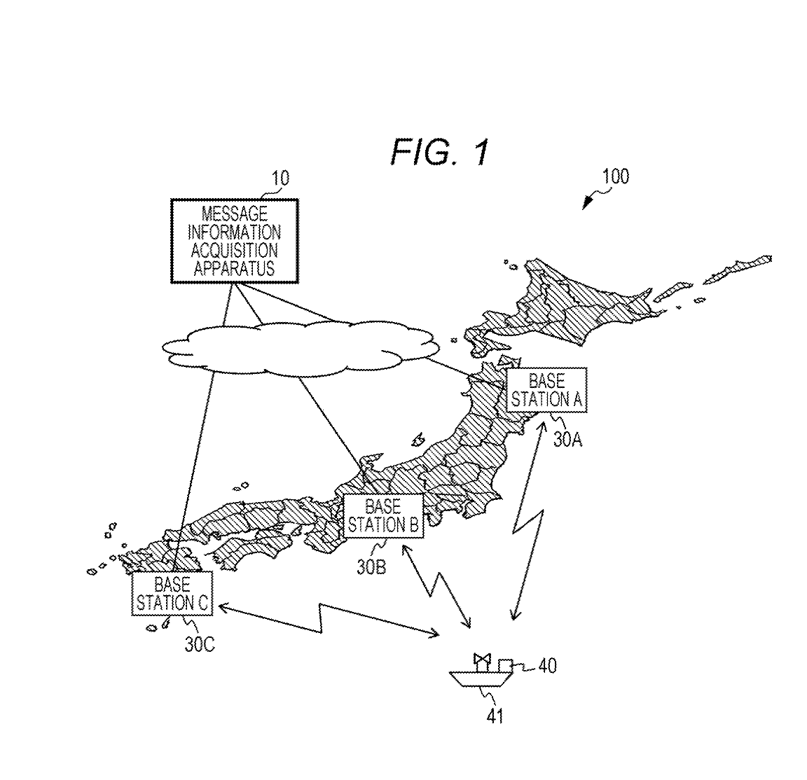

As illustrated in FIG. 1, a communication system 100 according to an embodiment includes a message information acquisition apparatus 10, base stations 30A, 30B, and 30C, and a communication terminal 40 carried on a ship 41, which is a mobile body. In the following description, when the base stations 30A, 30B, and 30C are explained without any distinction, these base stations are simply referred to as “base stations 30”. FIG. 1 illustrates an example in which three base stations 30 and one communication terminal 40 are included in the communication system 100, but the number of base stations 30 and communication terminals 40 is not limited, to the example in FIG. 1.

The message information acquisition apparatus 10 is an information processing apparatus such as a server or a personal computer provided on a cloud such as a data center. The base station 30 is an information processing apparatus having a communication function disposed in a facility of a fishery association or the, like provided, for example, in a coastal area, The base station 30 and the message information acquisition apparatus 10 are mutually connected via a network such as the Internet. Radio communication utilizing reflection of radio waves of a shortwave band frequency (about 3 to 30 MHz) in the ionosphere is performed between the base station 30 and the communication terminal 40.

In the communication utilizing the ionospheric reflection, communication is sometimes disabled because an area that radio waves reach changes and radio waves pass through the ionosphere depending on the condition of the ionosphere. For this reason, there is a high possibility that an error will occur in information exchanged between the base station 30 and the communication terminal 40. Accordingly, in the present embodiment, a message transmitted from the same communication terminal 40 is received by each of a plurality of base stations 30 such that the message is transferred from each base station 30 to the message information acquisition apparatus 10, and an error is repaired in the message information acquisition apparatus 10 using the plurality of transferred messages.

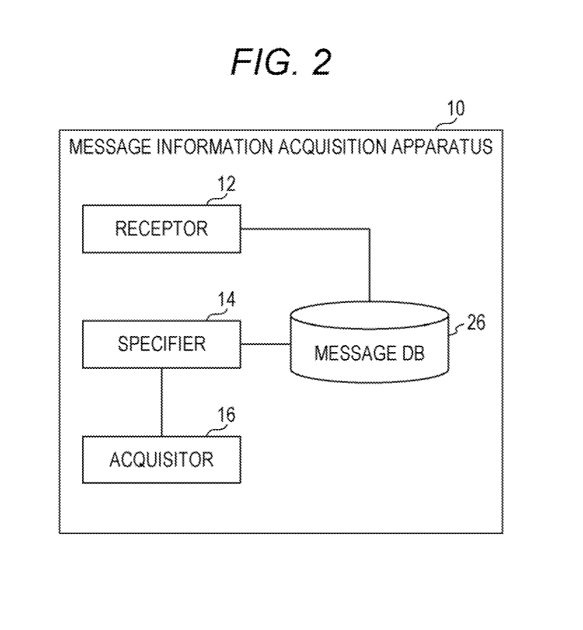

As illustrated in FIG. 2, the message information acquisition apparatus 10 functionally includes a receptor 12, a specifier 14, and an acquisitor 16, A message database (DB) 26 is stored in a predetermined storage area of the message information acquisition apparatus 10.

The receptor 12 receives a message from each of the base stations 30. As described above, in the present embodiment, a message transmitted from the same communication terminal 40 is received by each of the plurality of base stations 30 and transferred to the message information acquisition apparatus 10. Thus, the receptor 12 receives a plurality of messages indicating the same information from the plurality of respective base stations 30. The receptor 12 stores each of the received messages in the message DB 26.

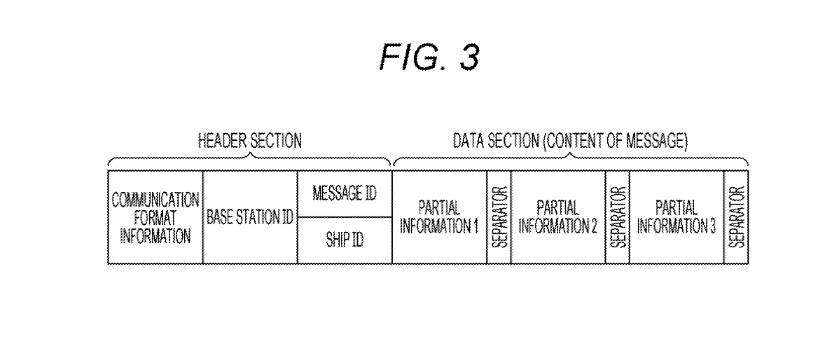

Here, FIG. 3 illustrates an example of a data format of the message. In the example in FIG. 3, the message includes a header section and a data section.

The header section retains communication format information, a base station ID which is identification information on the base station 30 which is a transfer source of the message, a message ID which is identification information on the message, identification information on the communication terminal 40 which is a transmission source of the message, and the like. The communication format information is, for example, information on radio wave model, communication technique, communication speed, modulation technique, dedicated bandwidth, and the like. In the present embodiment, a ship ID which is identification information on the ship 41 carrying the communication terminal 40 is used as the identification information on the communication terminal 40. The base station ID remains blank in the message transmitted from the communication terminal 40 and the base station ID is appended when the transmitted message is transferred from the base station 30 to the message information acquisition apparatus.

The data section is an area in which information indicated by the message (the content of the message) is retained, The information indicated by the message is divided into a plurality of parts such that each part is delimited by a separator and retained in the data section in a part basis error checkable format. Hereinafter, the information divided into each part is referred to as partial information. Each piece of the partial information is appended with a part ID which is identification information indicating which part of the information indicated by the message the partial information corresponds to.

For example, the separator is appended to the end of each piece of the partial information and includes an error detection code such as a parity bit, a checksum, a hash value, or a cyclic redundancy check (CRC) so as to be utilized for error check for each corresponding piece of the partial information.

The specifier 14 reads out messages indicating the same information, for example, messages including the same message ID in the header sections, from a plurality of messages stored in the message DB 26. The specifier 14 analyzes each read-out message and performs an error check using the error detection code included in the separator for each piece of the partial information in the data section of each message to specify partial information in which an error has occurred. The specifier 14 delivers, to the acquisitor 16, each of the messages in which partial information in which an error has occurred is specified.

For each part ID, the acquisitor 16 extracts partial information in which no error has occurred, from any of the plurality of messages delivered from the specifier 14, The acquisitor 16 joins each piece of the extracted partial information in order on the basis of the part ID of each piece of the partial information thereby acquiring the information indicated by the message. Thus, even if a certain message contains partial information in which an error has occurred, in a case where no error has occurred in the same partial information It another message with the same message ID, the partial information in which an error has occurred is suitably compensated and the information indicated by the message is satisfactorily reproduced.

In a case where an error occurs in the partial information with the same part ID in all of the messages with the same message ID, it is difficult to compensate the error and reproduce the entire information indicated by the message. Accordingly, when an error has occurred in the partial information with the same part ID in all of the messages with the same message ID, the acquisitor 16 transmits a retransfer instruction to at least one of the plurality of base stations 30 which are the transfer sources of the message. The retransfer instruction is an instruction to cause the communication terminal 40 to resend the corresponding message and to cause the base station 30 to retransfer the resent message to the message information acquisition apparatus 10. The retransfer instruction includes the message ID and the part ID of the message to be retransferred, and the ship ID of the ship carrying the communication terminal 40 as the transmission source of the message. The part ID is only required to be designated when the partial information in which an error has occurred is selectively retransferred; when the whole message including the partial information in which no error has occurred is retransferred, designation of the part ID may be omitted.

Furthermore, as the base station 30 to which the retransfer instruction is to be transmitted, the acquisitor 16 may target all the base stations 30 which are the transfer sources of the corresponding message, or may target any selected base station 30. When any of the base stations 30 is selected, for example, it is possible to select a base station 30 as the transfer source of the message with the lowest error occurrence rate. The error occurrence rate is a ratio of partial information in which an error has occurred to the total number of pieces of the partial information included in the data section of the message. Alternatively, the acquisitor 16 may select a base station 30 of which the reception strength when the corresponding message was received from the communication terminal 40 is equal to or greater than a predetermined value, In this case, for example, information on the reception strength may be included in the header section of the message.

The acquisitor 16 performs error compensation again on the basis of the message retransferred in response to the retransfer instruction. If the partial information in which an error has occurred stays in the message even using the retransferred message, the acquisitor 16 repeats the retransfer instruction.

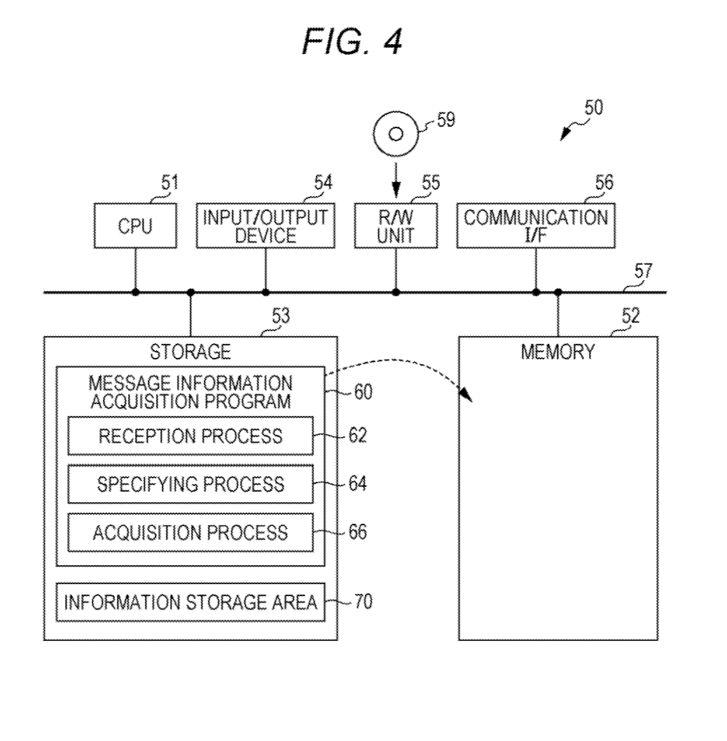

The message information acquisition apparatus 10 can be implemented for example, by a computer 50 illustrated in FIG. 4, The computer 50 includes a central processing unit (CPU) 51, a memory 52 as a temporary storage area, and a nonvolatile storage 53. The computer 50 also includes an input/output device 54, a read/write (R/W) unit 55 that controls reading and writing of data to and from a storage medium 59, and a communication interface (I/F) 56 connected to a network such as the Internet. The CPU 51, the memory 52, the storage 53, the input/output device 54, the R/W unit 55, and the communication I/F 56 are connected to each other via a bus 57.

The storage 53 can be implemented by a hard disk drive (HDD) a solid state drive (SSD), a flash memory, or the like, A message information acquisition program 60 for causing the computer 50 to function as the message information acquisition apparatus 10 is stored in the storage 53 as a storage medium. The message information acquisition program 60 has a reception process 62, a specifying process 64, and an acquisition process 66. The storage 53 has an information storage area 70 in which information constituting the message DB 26 is stored.

The CPU 51 reads out the message information acquisition program 60 from the storage 53 to develop in the memory 52 and sequentially executes the processes included in the message information acquisition program 60. The CPU 51 executes the reception process 62 to work as the receptor 12 illustrated in FIG. 2. The CPU 51 executes the specifying process 64 to work as the specifier 14 illustrated in FIG. 2. The CPU 51 executes the acquisition process 66 to work as the acquisitor 16 illustrated in FIG. 2, The CPU 51 also reads out information from the information storage area 70 and develops the message DB 26 in the memory 52. With these, procedures, the computer 50 executing the message information acquisition program 60 functions as the message information acquisition apparatus 10.

Functions implemented by the message information acquisition program 60 can also be implemented, for example, by a semiconductor integrated circuit, in more detail, an application specific integrated circuit (ASIC) or the like.

Next, the action of the communication system 100 according to the present embodiment will be described.

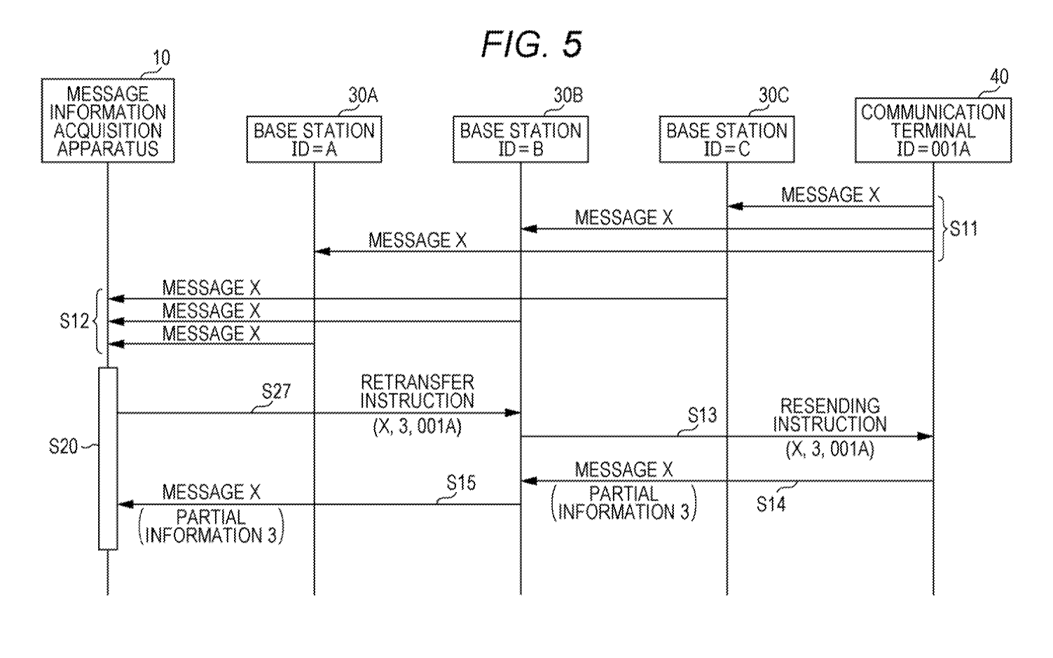

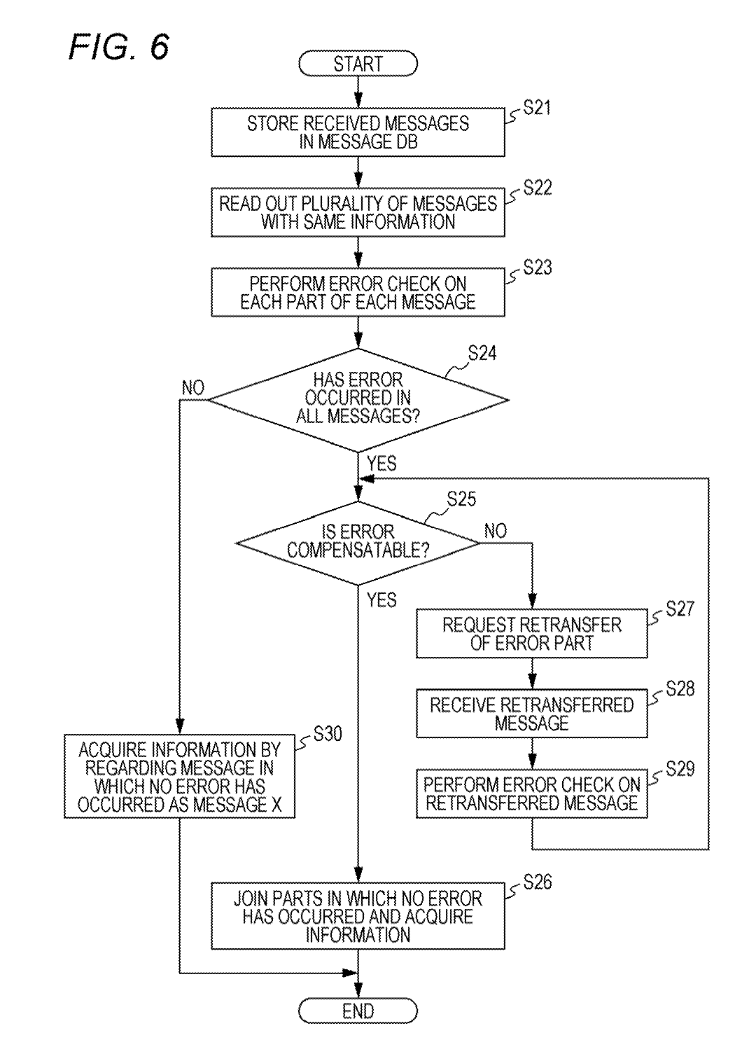

First, the exchange of information between the message information acquisition apparatus 10, the base stations 30A, 30B, and 30C, and the communication terminal 40 carried on the ship 41 with the ship ID=001A will be described with reference to a sequence diagram illustrated in FIG. 5. Note that it is assumed that the base station 30A has the base station ID=A, the base station 30B has the base station ID=B, and the base station 30C has the base station ID=C. The details of a message information acquisition process executed by the message information acquisition apparatus 10 will be explained precisely with reference to FIG. 6 described later.

First, a message with the message ID=X (hereinafter referred to as “message X”) is transmitted from the communication terminal 40 (S11), This example assumes that the message X transmitted from the communication terminal 40 is received by each of the base stations 30A, 30B, and 30C. Each of the base stations 30A, 306, and 30C which have received the message X appends its own base station ID to the message X and transfers the message appended with its own base station ID to the message information acquisition apparatus 10 (S12).

When the message information acquisition apparatus 10 receives the plurality of messages X transferred from the respective base stations 30A, 30B, and 30C, the message information acquisition process (S20) of which the details will be described later is started and an error in the message X is repaired, When the message X contains partial information with a difficulty in compensating an error, the message information acquisition apparatus 10 transmits the retransfer instruction to at least one of the base stations 30A, 30B, and 30C (in this example, the base station 30B) (S27). This example assumes that the retransfer instruction for partial information with the part ID=3 of the message X is transmitted (hereinafter, the partial information with the part ID is referred to as “partial information i”). The retransfer instruction thus includes the message ID=X, the part ID=3, and the ship ID=001A.

Upon receiving the retransfer instruction, the base station 30B transmits, to the communication terminal 40 indicated by the ship ID=001A included in the retransfer instruction, a resending instruction to instruct the resending of the partial information 3 of the message X indicated by the message ID and the part ID included in the retransfer instruction (S13)

The partial information 3 of the message X is transmitted from the communication terminal 40 in response to the resending instruction (S14). The base station 30B which has received the partial information 3 of the message X appends its own base station ID=B and transmits the partial information 3 of the message X to the message information acquisition apparatus 10 (S15).

Next, the message information acquisition process executed by the message information acquisition apparatus 10 will be described with reference to FIG. 6. Also in FIG. 6, as in the case of FIG. 5, a description will be given of a case where each of the base stations 30A, 30B, and 30C receives the message X transmitted from the communication terminal 40. When the message information acquisition apparatus 10 receives a message transferred from each base station 30, the message information acquisition process is executed in the message information acquisition apparatus 10. In the message information acquisition process illustrated in FIG. 6, processes similar to those in the sequence diagram illustrated in FIG. 5 are denoted by the same reference numerals.

In step S21, the receptor 12 stores each of the received messages in the message DB 26. Next, in step S22, the specifier 14 reads out messages indicating the same information, for example, messages including the same message ID in the header sections, from the plurality of messages stored in the message DB 26. In this example, three messages X with the message ID X are read out.

Next, in step S23, the specifier 14 analyzes each read-out message X and performs an error check for each piece of the partial information in the data section of each message to specify partial information in which an error has occurred. The specifier 14 delivers, to the acquisitor 16, each of the messages in which partial information in which an error has occurred is specified.

Next, in step S24, the acquisitor 16 ascertains whether an error has occurred in all of the plurality of messages X delivered from the specifier 14. When an error has occurred in all the messages X, the acquisitor 16 performs the process in step S25. When there is a message in which no error has occurred among the plurality of messages X, the acquisitor 16 acquires information indicated by the message X by regarding the message in which no error has occurred in step S30 as the message X; then, the message information acquisition process is terminated.

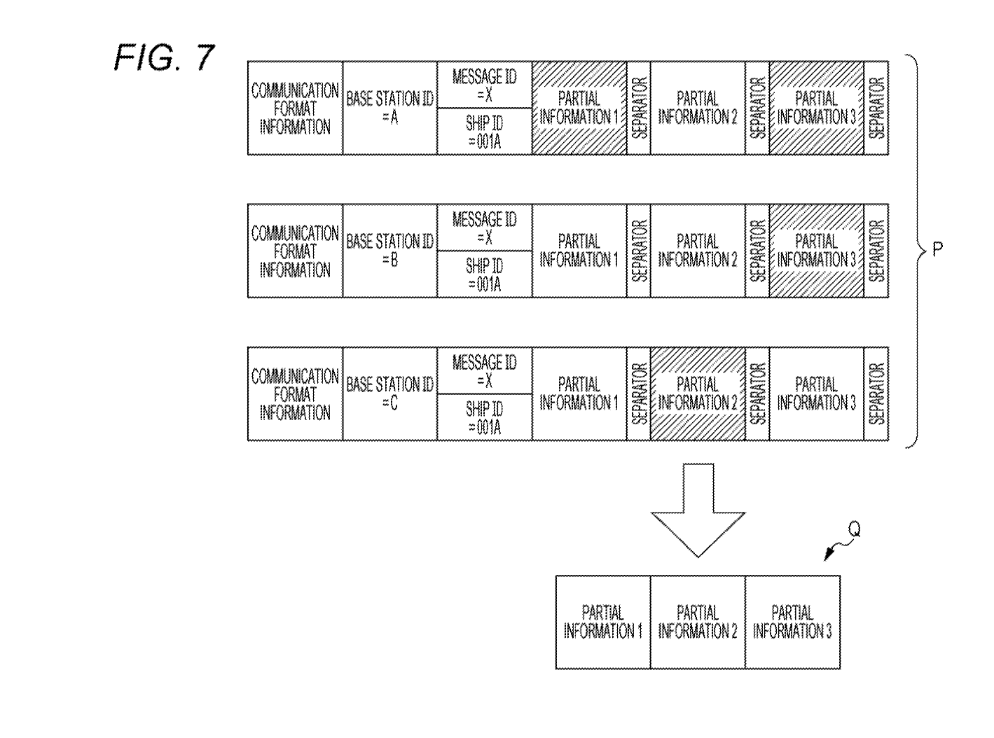

In step S25, the acquisitor 16 ascertains, for each part ID, whether any of the messages X contains partial information in which no error has occurred, for example, ascertains whether the error is compensatable. For example, as illustrated in P in FIG. 7, it is assumed that partial information in which an error has occurred is specified in each of the three messages X. In FIG. 7, the partial information in which an error has occurred is indicated by shading. In this case, partial information 1 is compensatable by the message X transferred from the base station 30B or 30C. Partial information 2 is compensatable by the message X transferred from the base station 30A or 30B. Partial information 3 is compensatable by the message X transferred from the base station 30C. Thus, an affirmative ascertainment is made in this step and the process proceeds to step S26.

In step S26, for each part ID, the acquisitor 16 extracts partial information in which no error has occurred, from one of the three messages. In the example in FIG. 7, the partial information 1 is extracted from the message X transferred from the base station 30B or 30C, the partial information 2 is extracted from the message X transferred from the base station 30A or 30B, and the partial information 3 is extracted from the message X transferred from the base station 30C. Then, the acquisitor 16 joins the extracted pieces of the partial information in the order of the partial information 1, the partial information 2, and the partial information 3 as illustrated in Q in FIG. 7 and acquires the information indicated by the message X. Subsequently, the message information acquisition process is terminated.

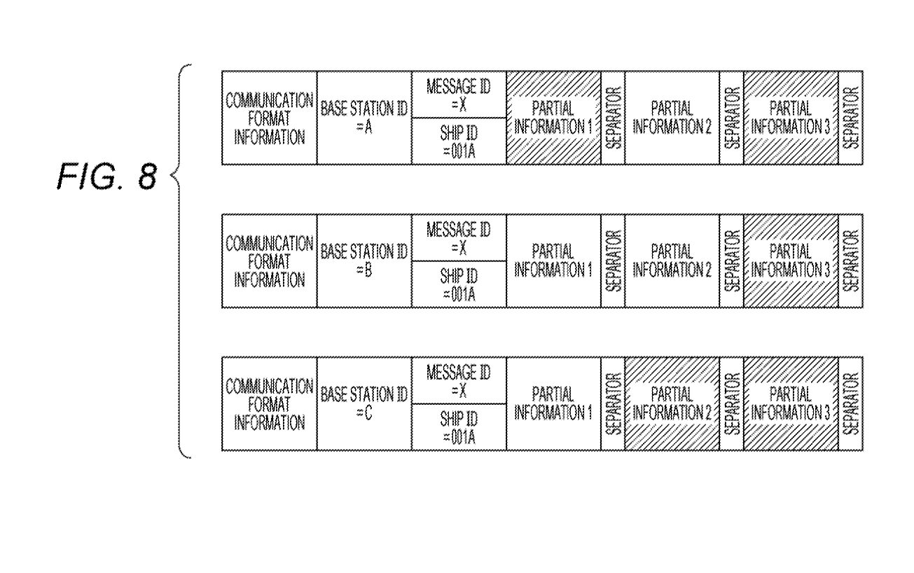

On the other hand, for example, as illustrated in FIG. 8, it is assumed that partial information in which an error has occurred is specified in each of the three messages X. In this case, an error has occurred in the partial information 3 in all the messages X and the partial information 3 is not compensatable. Therefore, a negative ascertainment is made in step S25 above and the process proceeds to step S27.

In step S27, the acquisitor 16 transmits the retransfer instruction for the partial information 3 to at least one of the plurality of base stations 30 which are the transfer sources of the message. This example assumes that the retransfer instruction is transmitted to the base station 30B that has transferred the message X having the lowest error occurrence rate. The acquisitor 16 includes the message ID=X, the part ID=3, and the ship ID=001A within the retransfer instruction.

Next, in step S28, the receptor 12 receives the partial information 3 of the message X retransferred from the base station 30B in response to the retransfer instruction. Next, in step S29, the specifier 14 performs an error check for the partial information 3 of the retransferred message X and the process returns to step S25. When it is specified, by the error check in step S29, that an error has occurred in the partial information 3 of the retransferred message X, a negative ascertainment is made in step S25 and the retransfer instruction is repeated.

On the other hand, when it is specified, by the error check in step S29, that no error has occurred in the partial information 3 of the retransferred message X, an affirmative ascertainment is made in step S25. Then, in next step S26, the acquisitor 16 extracts partial information in which no error has occurred for each part ID, including the partial information 3 of the retransferred message X, and joins the extracted pieces of the partial information to acquire the information indicated by the message X. Subsequently the message information acquisition process is terminated.

As described thus far, according to the message information acquisition apparatus of the present embodiment, using a plurality of messages indicating the same information transferred from a plurality of base stations that have each received a message transmitted from the communication terminal, an error check is performed for each piece of the partial information. Then, pieces of partial information in which no error has occurred are joined to acquire the information indicated by the message. Since the communication statuses between the plurality of respective base stations and the communication terminal are different from each other, there is a high possibility that the states of errors occurring in the messages received by the plurality of base stations are also different from each other. Thus, gathering messages received by the plurality of base stations increases the possibility of compensating partial information in which an error has occurred. With these procedures, even when the communication quality is low, information is satisfactorily acquired with high accuracy.

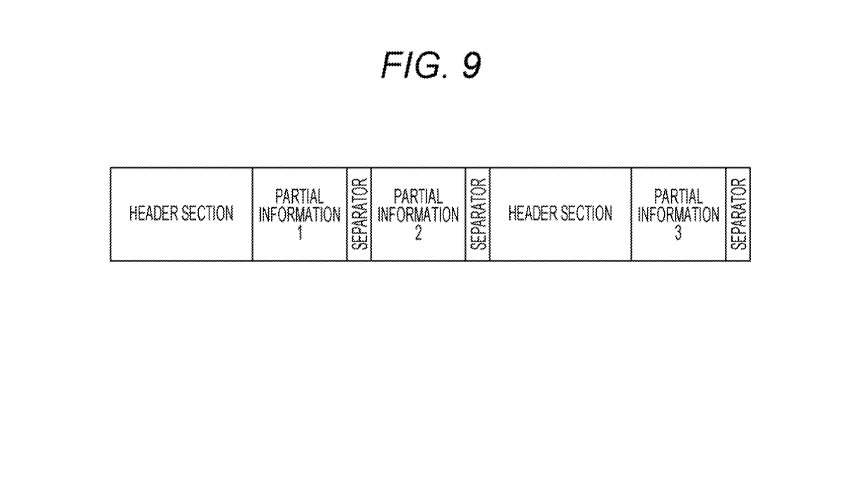

In the above embodiment, a case where one header section is provided at the top portion of the message has been described, but the present invention is not limited to this structure. For example, as illustrated in FIG. 9, a plurality of identical header sections may be provided in one message. In a case where one header section is included alone, it becomes difficult to identify the same message from among a plurality of messages if an error has occurred in the header section; consequently, the message with an error in the header section is no longer utilized for compensating partial information of another message in which an error has occurred. For this reason, if a plurality of header sections is provided as described above, the message ID or the like is promptly confirmed in another header section even when an error has occurred in any of the header sections and this message may be utilized for compensating partial information of another message in which an error has occurred.

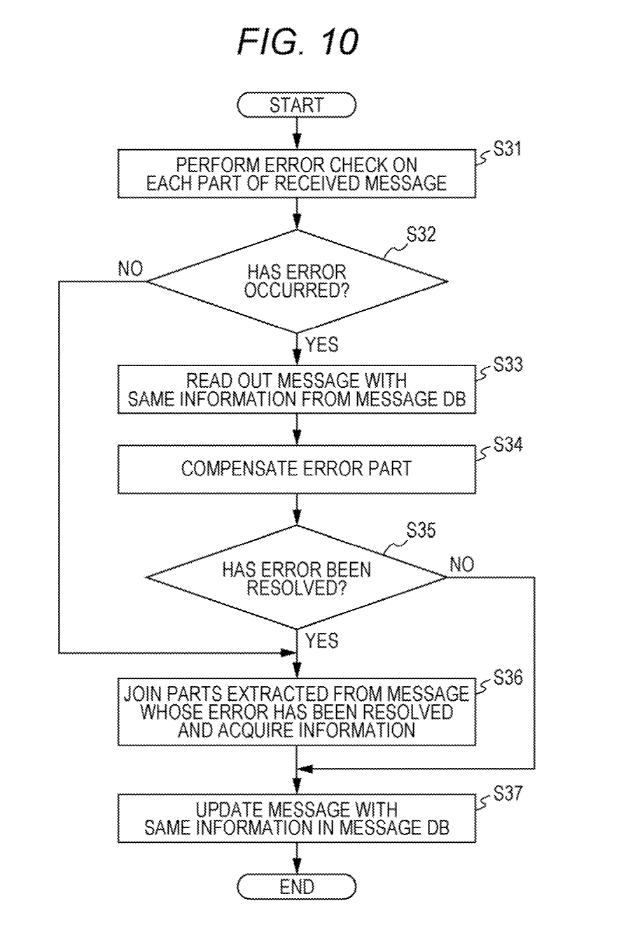

Furthermore, in the above embodiment, the description has been given of a case in which a plurality of messages indicating the same information is collectively utilized for compensating partial information in which an error has occurred, but the present invention is not limited to this procedure. Partial information of the same message that has already been received, in which an error has occurred, may be compensated every time a message is received. The message information acquisition process in this case will be described with reference to FIG. 10.

In step S31 of the message information acquisition process in FIG. 10, the specifier 14 performs an error check on each piece of the partial information of the received message. Next, in step S32, the acquisitor 6 ascertains whether an error has occurred in any piece of the partial information. When an error has occurred, the process proceeds to step S33 and the acquisitor 16 reads out a message with the same message ID from the message DB 26. In this example, the message DB 26 stores, for each message ID, a message in the latest state in which partial information in which an error has occurred has been sequentially compensated on the basis of one or a plurality of already received messages with the same message ID.

Next, in step S34, the partial information in which an error has occurred, which stays in the message read out in step S33 above, is compensated using a newly received message. For example, it is assumed that the message illustrated in the upper part of P in FIG. 7 is read out from the message DB 26 and the message illustrated in the middle part of P in FIG. 7 is newly received, In this case the partial information 1 is compensated by the newly received message.

Next, in step S35, the acquisitor 16 ascertains whether all pieces of the partial information in which an error has occurred, which stays in the message read out from the message DB 26, have been compensated by the newly received message, and an error in the message has been resolved. When an affirmative ascertainment is made, the process proceeds to step S36 and the acquisitor 16 extracts each piece of the partial information of the message whose error has been resolved and acquires the information indicated by the message, Also in a case where it is ascertained in step S32 above that no error has occurred in the newly received message, the acquisitor 16 acquires the information from the newly received message in step S36. Then, the process proceeds to step S37.

On the other hand, when it is ascertained in step S35 that, partial information in which an error has occurred still stays, step S36 is skipped and the process proceeds to step S37. In step S37, the acquisitor 16 updates the corresponding message stored in the message DB 26 to the message whose error has been compensated in step S34 above. For example, when the error has been resolved, a message without error is stored in the message DB 26; even if an error stays, a message in a state in which compensatable errors have been compensated by a plurality of identical messages received so far is stored in the message DB 26. Then, the message information acquisition process is terminated. Note that, when a message with the same message ID as that of a message without error stored in the message DB 26 is newly received, the process in FIG. 10 can be omitted.

Furthermore, the information of the message acquired in the above embodiment may be transmitted to the base station which is the transfer source of the message, if it is desirable.

In the above embodiment, communication between the communication terminal carried on the ship moving on the sea and the base station has been described as an example, but the present invention is not limited to this embodiment. The disclosed technology can also be applied to communication between a mobile body such as an airplane traveling in the sky and the base station, and communication between a communication terminal present on the ground such as mountains, deserts, or wide factories and the base station.

In the above embodiment, a case where the communication between the communication terminal and the base station is communication using the shortwave frequency has been described as an example, but the communication technique is not particularly limited. However, in a communication system of a technique in which a plurality of base stations receives a message transmitted from the communication terminal carried on the mobile body by utilizing the ionospheric reflection, respective communication conditions such as the frequency and the transfer speed can be appropriately set in each of the base stations depending on the status of the ionosphere. Therefore, as described above, it is expected that the possibility of compensating partial information in which an error has occurred increases by gathering messages received by the plurality of base stations, such that the application effect of the disclosed technology increases.

In addition, as in the present embodiment, the data format including a plurality of parts in one message is a data format that not only enables compensation of an error for each piece of the partial information but also is suitable for communication utilizing the ionospheric reflection. For example, in the communication utilizing the ionospheric reflection, communication with a lower transfer speed using a relatively narrow zone is performed. For this reason, a technique of appending a header to each packet obtained by dividing information finely, like packet communication using an Internet line, is not suitable for communication utilizing the ionospheric reflection because the amount of information to be transferred grows large. As in the present embodiment, in the case of a data format in which a plurality of parts is included in one message and the header section is not required for each of these parts, the amount of information to be transferred is preferably suppressed, as compared with the case of the above-described packet communication; it is thus particularly effective in the communication utilizing the ionospheric reflection.

In the above description, a mode in which the message information acquisition program 60, which is an example of the program according to the disclosed technology, is stored (installed) in advance in the storage 53 has been described, but the present invention is not limited to this mode. The program according to the disclosed technology can also be provided in a form stored in a storage medium such as a compact disc read only memory (CD-ROM), a digital versatile disc read only memory (DVD-ROM), or a universal serial bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a message information acquisition program for causing a computer to execute a process comprising:
receiving, from each of a plurality of base stations that receive a first message which is transmitted by a communication terminal, a second message in which information indicated by the first message is divided into parts each in an error checkable format;
performing an error check for each of the parts;
extracting, in each of a plurality of second messages indicating the same information, a divided piece of information from one or more parts without an error of the parts;
joining the divided pieces of information; and
acquiring the information indicated by the first message.

2. The non-transitory computer-readable recording medium according to claim 1, wherein, when a specific part in each of all of the plurality of second messages the error, an instruction to cause the communication terminal to resend the first message is transmitted to at least one of the plurality of base stations.

3. The non-transitory computer-readable recording medium according to claim 2, wherein at least one of the plurality of base stations is a base station of which a ratio of parts with the error to a total number of the parts is equal to or less than a first value, or a base station of which reception strength at the time of receiving the first message from the communication terminal is equal to or greater than a second value.

4. The non-transitory computer-readable recording medium according to claim 2, wherein an instruction to cause the communication terminal to resend the specific part alone is transmitted as the instruction to cause the communication terminal to resend the message.

5. The non-transitory computer-readable recording medium according to claim 1, wherein the second message includes identification information to identify that the second message indicates the same information.

6. The non-transitory computer-readable recording medium according to claim 1, wherein the communication terminal is carried on a mobile body, communication utilizing ionospheric reflection is performed between the communication terminal and each of the plurality of base stations, and the plurality of base stations is settable with communication conditions different from each other.

7. An information processing apparatus comprising:
a memory; and
a processor coupled to the memory and configured to execute process of:
receiving, from each of a plurality of base stations that receive a first message which is transmitted by a communication terminal, a second message in which information indicated by the first message is divided into parts each in an error checkable format;
performing an error check for each of the parts;
extracting, in each of a plurality of second messages indicating the same information, a divided piece of information from one or more parts without an error of the parts;
joining the divided pieces of information; and
acquiring the information indicated by the first message.

8. The information processing apparatus according to claim 7, wherein, when a specific part in each of all of the plurality of second messages the error, an instruction to cause the communication terminal to resend the first message is transmitted to at least one of the plurality of base stations.

9. The information processing apparatus according to claim 8, wherein at least one of the plurality of base stations is a base station of which a ratio of parts with the error to a total number of the parts is equal to or less than a first value, or a base station of which reception strength at the time of, receiving the first message from the communication terminal is equal to or greater than a second value.

10. The information processing apparatus according to claim 8, wherein an instruction to cause the communication terminal to resend the specific part alone is transmitted as the instruction to cause the communication terminal to resend the message.

11. The information processing apparatus according to claim 7, wherein the second message includes identification information to identify that the second message indicates the same information.

12. The information processing apparatus according to claim 7, wherein the communication terminal is carried on a mobile body, communication utilizing ionospheric reflection is performed between the communication terminal and each of the plurality of base stations, and the plurality of base stations is settable with communication conditions different from each other.

13. A message information acquisition method comprising:
receiving, by a computer, from each of plurality of base stations that receive a first message which is transmitted by a communication terminal, a second message in which information indicated by the first message is divided into parts each in an error checkable format;
performing an error check for each of the parts;
extracting, in each of a plurality of second messages indicating the same information, a divided piece of information from one or more parts without an error of the parts;
joining the divided pieces of information; and
acquiring the information indicated by the first message.

14. The message information acquisition method according to claim 13, wherein, when a specific part in each of all of the plurality of second messages the error, an instruction to cause the communication terminal to resend the first message is transmitted to at least one of the plurality of base stations.

15. The message information acquisition method according to claim 14, wherein at least one of the plurality of base stations is a base station of which a ratio of parts with the error to a total number of the parts is equal to or less than a first value, or a base station of which reception strength at the time of receiving the first message from the communication terminal is equal to or greater than a second value.

16. The message information acquisition method according to claim 14, wherein an instruction to cause the communication terminal to resend the specific part alone is transmitted as the instruction to cause the communication terminal to resend the message.

17. The message information acquisition method according to claim 13, wherein the second message includes identification information to identify that the second message indicates the same information.

18. The message information acquisition method according to claim 13, wherein the communication terminal is carried on a mobile body, communication utilizing ionospheric reflection is performed between the communication terminal and each of the plurality of base stations, and the plurality of base stations is settable with communication conditions different from each other.
